(19) United States
(12) Patent Application Publication
(10) Pub. No.: US 2017/0018829 A1
(43) Pub. Date: Jan. 19, 2017

(54) DIELECTRIC SLAB INTERLOCKING DEVICE OF A PHASE SHIFTER

(71) Applicants: Yu-Chia HSU, Taichung City (TW); Pao-Wei LIN, Hsinchu County (TW)

(72) Inventors: Yu-Chia HSU, Taichung City (TW); Pao-Wei LIN, Hsinchu County (TW)

(73) Assignee: WHA YU INDUSTRIAL CO., LTD., Hsinchu City (TW)

(21) Appl. No.: 14/801,285

(22) Filed: Jul. 16, 2015

(51) Int. Cl. H01P 1/18

(52) U.S. Cl. CPC H01P 1/182

(57) ABSTRACT

A dielectric slab interlocking device is movably mounted onto a feed layer of the phase shifter for moving multiple dielectric slabs relative to a phase shifting circuit unit on the feed layer. The dielectric slab interlocking device is divided into a fork-shaped interlocking section and a driven section. The fork-shaped interlocking section includes a first fork rod and a second fork rod, wherein the dielectric slabs are respectively disposed on the two fork rods and the driven section is sandwiched between the two fork rods. The first fork rod and the second fork rod are respectively movably disposed on two opposite sides of the feed layer such that the feed layer is situated between the first fork rod and the second fork rod, wherein the first fork rod and the second fork rod with all the dielectric slabs are moved when the driven section is driven.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a dielectric slab interlocking device, and more particularly to a dielectric slab interlocking device of a phase shifter.

2. Description of Related Art Including Information Disclosed Under 37 CFR 1.97 and 37 CFR 1.98.

As well known, a phase shifter is used to adjust the phase of electric wave and move the phase of a signal to a specific angle. However, the operating modes for various phase shifters are different from each other due to the structures thereof.

The phase shifter is integrated into array antenna product structures extensively, and different radiators in an antenna can feed in signals of different phases by the adjustment of the phase shifter, so as to radiate beams in different directions in space.

The phase shifter includes a dielectric slab interlocking device disposed therein and be capable of moving the dielectric slab along the phase shifting circuit unit on a feed layer for achieving the purpose of phase adjustment. The structures of the dielectric slab interlocking device of the conventional phase shifter are provided for a feed layer which is single-sided such that the conventional dielectric slab interlocking device only considers about a low technical level. However, two dielectric slab interlocking devices for a double-sided feed layer are needed when the feed layer is altered from a single-sided structure to a double-sided structure. As a result, the structures of the phase shifter become complicated, and the cost of the phase shifter is greatly raised for the conventional phase shifter with a double-sided feed layer.

The present invention has arisen to mitigate and/or obviate the disadvantages of the conventional phase shifters.

### BRIEF SUMMARY OF THE INVENTION

The main objective of the present invention is to provide an improved dielectric slab interlocking device of a phase shifter, which has a simplified structure and can be easily assembled.

To achieve the objective, the dielectric slab interlocking device in accordance with the present invention is movably mounted onto a feed layer of the phase shifter for moving multiple dielectric slabs relative to a corresponding of multiple phase shifting circuit units that are disposed on the feed layer. The feed layer has a front side and a rear side, and a circuit laying layer is formed on the front side of the feed layer. The dielectric slab interlocking device is divided into a driven section and a fork-shaped interlocking section, wherein the driven section is a rod and the fork-shaped interlocking section includes a first fork rod and a second fork rod respectively connected to two opposite sides of the driven section such that a gap is defined between the first fork rod and the second fork rod for receiving the feed layer. The first fork rod and the second fork rod respectively include two opposite sides having multiple dielectric slabs laterally formed thereon, wherein each dielectric slab on the first fork rod aligns with a corresponding one of the dielectric slabs on the second fork rod, and the aligned dielectric slabs on the first fork rod and the second fork rod are simultaneously moved relative to a corresponding one of the multiple phase shifting circuit units on the feed layer when the driven section is driven.

Further benefits and advantages of the present invention will become apparent after a careful reading of the detailed description with appropriate reference to the accompanying drawings.

### BRIEF DESCRIPTION OF THE SEVERAL VIEWS OF THE DRAWINGS

FIG. 1 is an exploded perspective view of phase shifter, wherein a dielectric slab interlocking device in accordance with the present invention is movably mounted therein;

FIG. 2 is a is a perspective view of phase shifter, wherein a dielectric slab interlocking device in accordance with the present invention is movably mounted therein;

FIG. 3 is a partial enlarged view of the dielectric slab interlocking device of a phase shifter in accordance with the present invention;

FIG. 4 is a partially cross-sectional view of the dielectric slab interlocking device in accordance with the present invention;

FIG. 5 is a first operational view of the dielectric slab interlocking device in accordance with the present invention;

FIG. 6 is a second operational view of the dielectric slab interlocking device in accordance with the present invention; and

FIG. 7 is a partially exploded perspective view of a second embodiment of the dielectric slab interlocking device in accordance with the present invention.

### DETAILED DESCRIPTION OF THE INVENTION

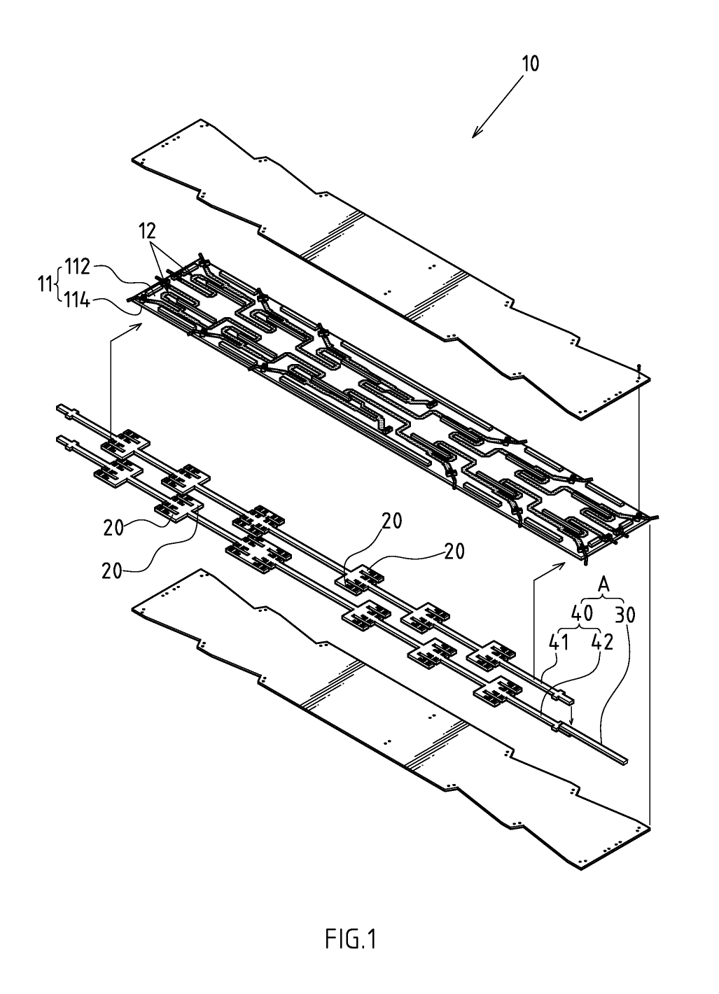

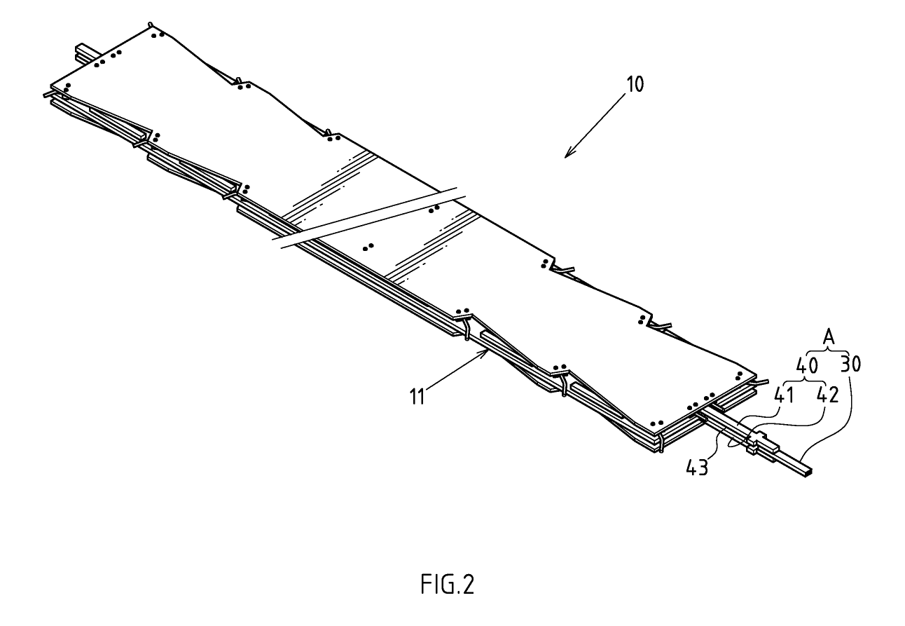

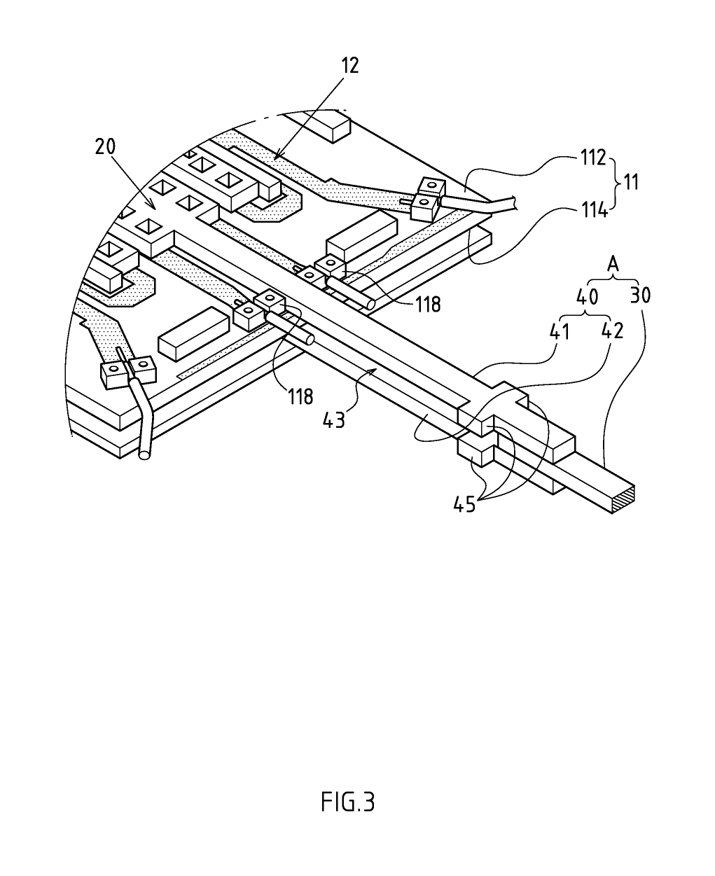

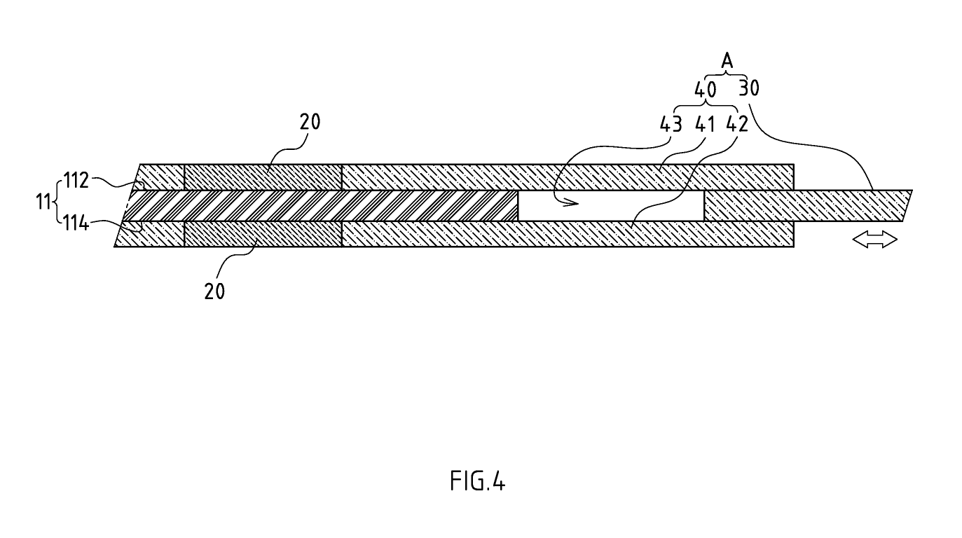

Referring to the drawings and initially to FIGS. 1-4, a dielectric slab interlocking device A for a phase shifter in accordance with the present invention is adapted to be movably mounted relative to a feed layer 11 of a phase shifter 10 for driving multiple dielectric slabs 20 moved relative to a corresponding one of multiple phase shifting circuit units 12 that are disposed on the feed layer 11. The feed layer 11 includes a front side and a rear side 114, wherein a circuit laying layer 112 is formed on the front side of the feed layer 11. The dielectric slab interlocking device A is divided into a driven section 30 and a fork-shaped interlocking section 40, wherein the driven section 30 is a rod and the fork-shaped interlocking section 40 includes a first fork rod 41 and a second fork rod 42 respectively connected to two opposite sides of the driven section 30 such that a gap 43 (as shown in FIGS. 3 and 4) is defined between the first fork rod 41 and the second fork rod 42 for receiving the feed layer 11. The first fork rod 41 and the second fork rod 42 respectively include two opposite sides having multiple dielectric slabs 20 formed thereon, wherein each dielectric slab 20 on the first fork rod 41 aligns with a corresponding one of the dielectric slabs 20 on the second fork rod 42, and the aligned dielectric slabs 20 on the first fork rod 41 and the second fork rod 42 are simultaneously move relative to a corresponding one of the multiple phase shifting circuit units 12 on the feed layer 11 when the driven section 30 is driven.

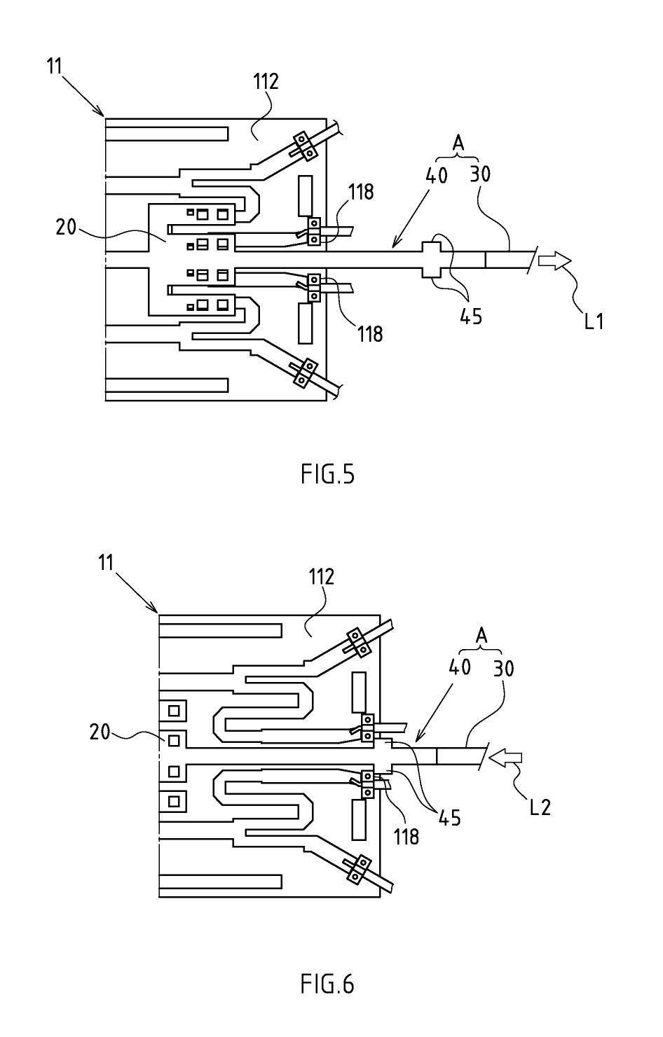

With reference to FIGS. 5 and 6, all the dielectric slabs 20 are simultaneously moved with the driven section 30 when the driven section 30 is reciprocally driven such that the relative position between the phase shifting circuit unit 12 on the feed layer 11 and the corresponding dielectric slabs 20 is changed, and the phase is changed and the phase shifting rate is adjusted, wherein the phase shifting rate is directly proportional to the covered area of the phase shifting circuit unit 12. Accordingly, the phase shifting rang corresponds to the covering area and the overlapping length between the dielectric slabs and the phase shifting circuit unit 12 on the feed layer 11. The dielectric slab interlocking device A in accordance with the present invention simultaneously moves the first fork rod 41 and the second fork rod 42 of the fork-shaped interlocking section 40 by using the driven section 30 such that the structures of the dielectric slab interlocking device A are simplified and can be easily assembled.

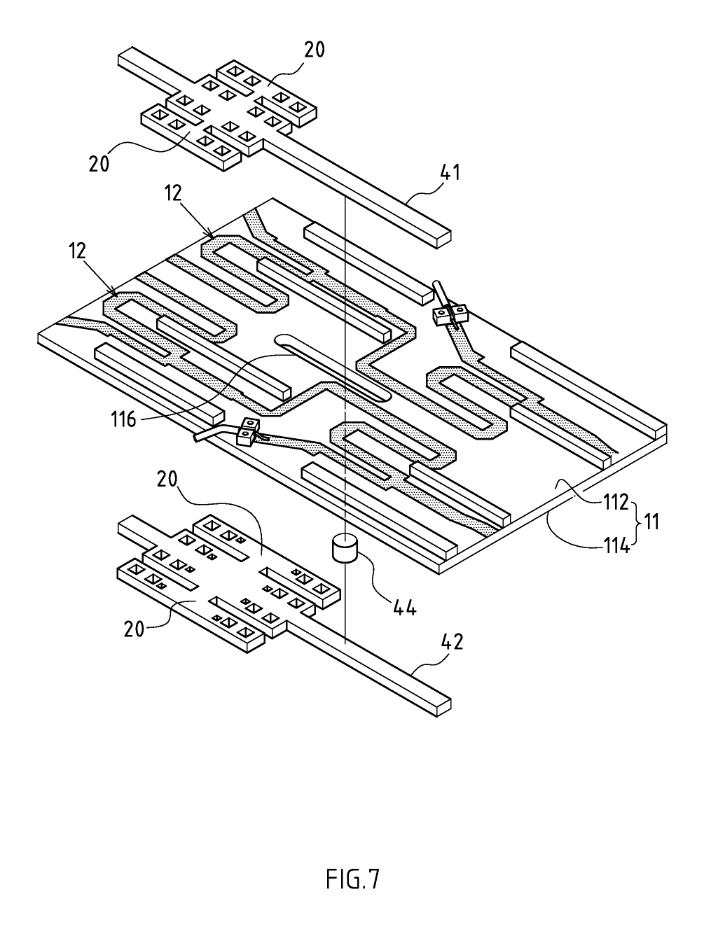

With reference to FIG. 7, the feed layer 11 includes a elongated through hole 116 defined therein. The fork-shaped interlocking section 40 includes a block 44 movably received in the elongated through hole 116, and connected to the first fork rod 41 and the second fork rod 42 such that the moving distance of the first fork rod 41 and the second fork rod 42 is limited.

With reference to FIG. 1, each of the first fork rod 41 and the second fork rod 42 has multiple dielectric slabs 20 disposed on two opposite sides thereof, wherein each dielectric slab 20 extends along a moving direction of the fork-shaped interlocking section 40 and is moved relative to a corresponding one of the phase shifting circuit units 12 on the feed layer 11.

With reference to FIGS. 3 and 6, the first fork rod 41 and the second fork rod 42 respectively include at least one stopper 45 laterally extending therefrom and the feed layer 11 has at least two limiters 118 secured thereon, wherein the at least two limiters 118 respectively align with the at least one stopper 45 of each of the first fork rod 41 and the second fork rod 42. Consequently, each stopper 45 is selectively engaged to a corresponding one of the at least two limiters 118 to position the dielectric slab interlocking device A when the dielectric slab interlocking device A is moved to a preset distance.

The driven section rod 30, the fork-shaped interlocking section 40 and the dielectric slab 20 of the dielectric slab interlocking device A in accordance with the present invention are preferably made of acrylic that is a high dielectric material, not be restricted.

The dielectric slab interlocking device A in accordance with the present invention includes the driven section 30 and the fork-shaped interlocking section 40 including the first fork rod 41 and the second fork rod 42. Each of the first fork rod 41 and the second fork rod 42 has multiple dielectric slabs 20 laterally disposed thereon and a gap 43 is defined between the first fork rod 41 and the second fork rod 42 for receiving the feed layer 11. As a result, the dielectric slab interlocking device A in accordance with the present invention simultaneously moves the first fork rod 41 and the second fork rod 42 of the fork-shaped interlocking section 40 by driving the driven section 30 such that the structures of the dielectric slab interlocking device A are simplified and can be easily assembled.

Although the invention has been explained in relation to its preferred embodiment, it is to be understood that many other possible modifications and variations can be made without departing from the spirit and scope of the invention as hereinafter claimed.

We claim:

1. A dielectric slab interlocking device of a phase shifter adapted to be movably mounted onto a feed layer of the phase shifter for moving multiple dielectric slabs relative to a corresponding of multiple phase shifting circuit units that are disposed on the feed layer, wherein the feed layer has a front side and a rear side and a circuit laying layer is formed on the front side of the feed layer, the dielectric slab interlocking device divided into a driven section and a fork-shaped interlocking section, wherein the driven section is a rod and the fork-shaped interlocking section includes a first fork rod and a second fork rod respectively connected to two opposite sides of the driven section such that a gap is defined between the first fork rod and the second fork rod for receiving the feed layer, the first fork rod and the second fork rod respectively including two opposite sides having multiple dielectric slabs laterally formed thereon, wherein slab each dielectric slab on the first fork rod aligns with a corresponding one of the dielectric slabs on the second fork rod, and the aligned dielectric slabs on the first fork rod and the second fork rod are simultaneously moved relative to a corresponding one of the multiple phase shifting circuit units on the feed layer when the driven section is driven.

2. The dielectric slab interlocking device of a phase shifter as claimed in claim 1, wherein each of the first fork rod and the second fork rod has multiple dielectric slabs disposed on two opposite sides thereof, each dielectric slab extending along a moving direction of the fork-shaped interlocking section and moved relative to a corresponding one of the phase shifting circuit units on the feed layer.

3. The dielectric slab interlocking device of a phase shifter as claimed in claim 2, wherein the first fork rod and the second fork rod respectively include at least one stopper laterally extending therefrom and the feed layer has at least two limiters secured thereon, the at least two limiters respectively aligning with the at least one stopper of each of the first fork rod and the second fork rod such that each stopper is selectively engaged to a corresponding one of the at least two limiters to position the dielectric slab interlocking device when the dielectric slab interlocking device is moved to a preset distance.

4. The dielectric slab interlocking device of a phase shifter as claimed in claim 3, wherein the feed layer includes a elongated through hole defined therein and the fork-shaped interlocking section includes a block movably received in the elongated through hole, the block connected to the first fork rod and the second fork rod such that the moving distance of the first fork rod and the second fork rod is limited.

5. The dielectric slab interlocking device of a phase shifter as claimed in claim 4, wherein the driven section, the fork-shaped interlocking section and the dielectric slab are made of acrylic that is a high dielectric material.
